(19) United States
(12) Patent Application Publication
(10) Pub. No.: US 2020/0348758 A1
(43) Pub. Date: Nov. 5, 2020

(54) COMMAND ACTIVATION BASED ON HAND GESTURE RECOGNITION

(71) Applicant: YUTOU TECHNOLOGY (HANGZHOU) CO., LTD., Hangzhou City (CN)

(72) Inventors: Zhaohui ZHANG, Hangzhou City (CN); Mingxiu CHEN, Hangzhou City (CN)

(21) Appl. No.: 16/863,825

(22) Filed: Apr. 30, 2020

(30) Foreign Application Priority Data
May 5, 2019 (CN) 201910368066.9

(51) Int. Cl. G06F 3/01; G06F 3/0481; G06F 3/0482; G06K 9/00; G06T 19/00

(52) U.S. Cl. CPC G06F 3/017; G06F 3/011; G06T 19/006; G06F 3/0482; G06K 9/00355; G06F 3/04815

(57) ABSTRACT

Aspects for hand gesture activated commands in a virtual reality (VR), an augmented reality (AR), or a mixed reality (MR) system (collectively “visual enhancement system”) are described herein. As an example, the aspects may include recognizing hand gestures in front of a depth camera and performing one or more commands in response to the recognized hand gestures. The hand gesture activated commands may include performing operations such as initiating an application, terminating the application, opening a start menu, etc.

### BACKGROUND OF THE INVENTION

A visual enhancement system may refer to a head-mounted device that provides supplemental information associated with real-world objects. For example, the visual enhancement system may include a near-eye display configured to display the supplemental information. Typically, the supplemental information may be displayed adjacent to the real-world objects. For instance, a movie schedule may be displayed by a movie theater such that the user may not need to search for movie information when he/she sees the movie theater.

Conventionally, a visual enhancement system may further include remote controllers for receiving inputs or commands from the user. For example, two motion-tracking input devices may be included in the visual enhancement system for receiving commands from the user. However, the remote controllers may require additional power supply and transmission of wireless signals to and from the head-mounted device.

### SUMMARY OF THE INVENTION

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

One example aspect of the present disclosure provides an example method for user interaction in a visual enhancement system. The example method may include collecting, by a depth camera, a depth map of a hand. The example method may further include identifying, by a joint analyzer, one or more joints of the hand in the depth map and determining, by a gesture analyzer, a gesture of the hand based on the identified joints in the depth map. In addition, the example method may include, in response to the determined gesture, performing, by a command response component, a corresponding operation.

Another example aspect of the present disclosure provides an example system for user interaction in a visual enhancement system. The example system may include a depth camera configured to collect a depth map of a hand. The example system may further include a joint analyzer configured to identify one or more joints of the hand in the depth map and a gesture analyzer configured to determine a gesture of the hand based on the identified joints in the depth map. In addition, the example system may include a command response component configured to perform a corresponding operation in response to the determined gesture.

To the accomplishment of the foregoing and related ends, the one or more aspects comprise the features herein after fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCIPTIOIN OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example visual enhancement system configured to recognize dynamic hand gestures;

FIG. 2 illustrates the example visual enhancement system configured to recognize other dynamic hand gestures;

FIG. 3 is a block diagram that illustrates the example visual enhancement system by which command activation based on hand gesture recognition may be implemented;

FIG. 4 illustrates an example menu displayed by the example visual enhancement system in response to one or more dynamic hand gestures; and

FIG. 5 is a flow chart of an example method for command activation based on hand gesture recognition.

### DETAILED DESCRIPTION

Various aspects are now described with reference to the drawings. In the following description, for purpose of explanation, numerous specific details are set forth in order to provide a thorough understanding of one or more aspects. It may be evident, however, that such aspect(s) may be practiced without these specific details.

In the present disclosure, the term “comprising” and “including” as well as their derivatives mean to contain rather than limit; the term “or”, which is also inclusive, means and/or.

In this specification, the following various embodiments used to illustrate principles of the present disclosure are only for illustrative purpose, and thus should not be understood as limiting the scope of the present disclosure by any means. The following description taken in conjunction with the accompanying drawings is to facilitate a thorough understanding to the illustrative embodiments of the present disclosure defined by the claims and its equivalent. There are specific details in the following description to facilitate understanding. However, these details are only for illustrative purpose. Therefore, persons skilled in the art should understand that various alternation and modification may be made to the embodiments illustrated in this description without going beyond the scope and spirit of the present disclosure. In addition, for clear and concise purpose, some known functionality and structure are not described. Besides, identical reference numbers refer to identical function and operation throughout the accompanying drawings.

A visual enhancement system disclosed hereinafter may include a depth camera configured to collect a depth map of a hand of the user. The depth map may include distance information that include distances from joints of the hand to the depth camera. Based on the depth map, the visual enhancement system may be configured to recognize the joints of the hand and further recognize hand gestures according to relative positions of the joints. In response to the recognized hand gestures, the visual enhancement system may be configured to execute commands respectively associated with the hand gestures. As such, remote controllers may not be necessary for inputting commands to the visual enhancement system.

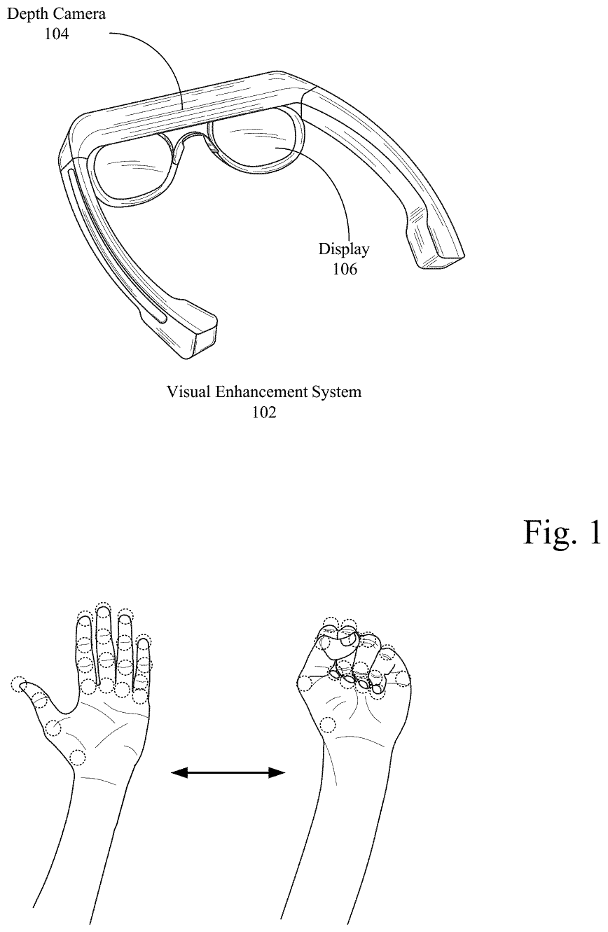

FIG. 1 illustrates an example visual enhancement system 102 configured to recognize dynamic hand gestures.

As depicted, the example visual enhancement system 102 may include a depth camera 104 and a display 106. The depth camera 104 may refer a camera configured to measure distances between the camera and one or more objects. The display 106 may be configured to display information on the lenses of the visual enhancement system 102. In some examples, the depth camera 104 may refer to a time-of-flight (ToF) camera configured to measure the respective round-trip time of light signals emitted from the camera to the one or more objects and reflected from the objects to the camera. By measuring the round-trip time of the light signals, the depth camera 104 may be configured to determine the distances based on the known speed of light. As such, an object captured by the depth camera 104 may be associated with a three-dimensional location that includes coordinates in a two-dimensional image and a distance. In other examples, the depth camera 104 may be implemented based on structured light or stereo vision system.

In general, when the depth camera 104 captures a depth map, a processing unit (e.g., a processing unit 302) may be configured to determine whether a hand is included in the depth map. Such determination may be performed based on neural network training, e.g., detecting hands based on machine learning. With similar technology, the processing unit may be configured to detect and identify joints of the hand in the depth map. In some examples, the processing unit may also be configured to detect and identify fingertips of the hand. The identified joints and fingertips are illustrated in FIG. 1 by the dotted circles.

That is, the depth map may include the three-dimensional location of the joints and/or the fingertips of the hand.

Based on the depth map that includes the identified joints of the hand, the processing unit may be further configured to determine a hand gesture of the hand. In at least some examples, the processing unit may be configured to count straightened fingers of the hand based on the distances from respective fingertips to a center of the palm. For example, if a count of the straightened fingers is five, the processing unit may be configured to determine the hand gesture to be an open hand. If the count of the straightened fingers is zero, the processing unit may determine the hand gesture to be a fist. If the count of the straighten fingers is one, the hand gesture may be determined to be one finger. Other gestures such as two straightened fingers may also be identified similarly based on the count.

Further, the processing unit may be configured to generate hand states and store the hand states as a hand state history. Each hand state may include a determined hand gesture and corresponding three-dimensional locations of the joints. For example, a hand state may include information that indicates a hand gesture of “fist” and the corresponding three-dimensional locations of the joints. In another example, a hand state may include information that indicates a hand gesture of “open hand” and the corresponding three-dimensional locations of the joints. The generated hand states may be stored as the hand state history with time stamps associated with each hand state.

In some examples, when the processing unit recognize a current hand state, the processing unit may be configured to compare the current hand state with a previously recognized hand state stored in the hand state history in order to determine a dynamic hand gesture. For example, the processing unit may recognize a current hand state that indicates a fist and store the current hand state in the hand state history. If the current hand state indicates a fist and a previously recognized hand state indicates an open hand, the processing unit may be configured to determine the dynamic hand gesture as “close a hand.” In one or more embodiments of the claimed invention, the processing unit may be configured to determine a dynamic hand gesture at the frequency of the depth camera or at a frequency pre-determined by the user, e.g., 24 frames per second to 60 frames per second.

Similarly, the processing unit may be configured to determine a dynamic hand gesture as “open a hand” if the current hand state is recognized as “open hand” and the previously recognized hand state indicates “fist.”

With respect to each dynamic hand gesture, the processing unit may be configured to attach additional information. For example, the additional information may include displacements of the joints and fingertips. That is, changes of the locations of the joints and fingertips between the current hand state and the previously recognized hand state may be attached to the dynamic hand gesture. A combination of a dynamic hand gesture and the displacements of the joints and fingertips may be stored and referred to as a gesture command.

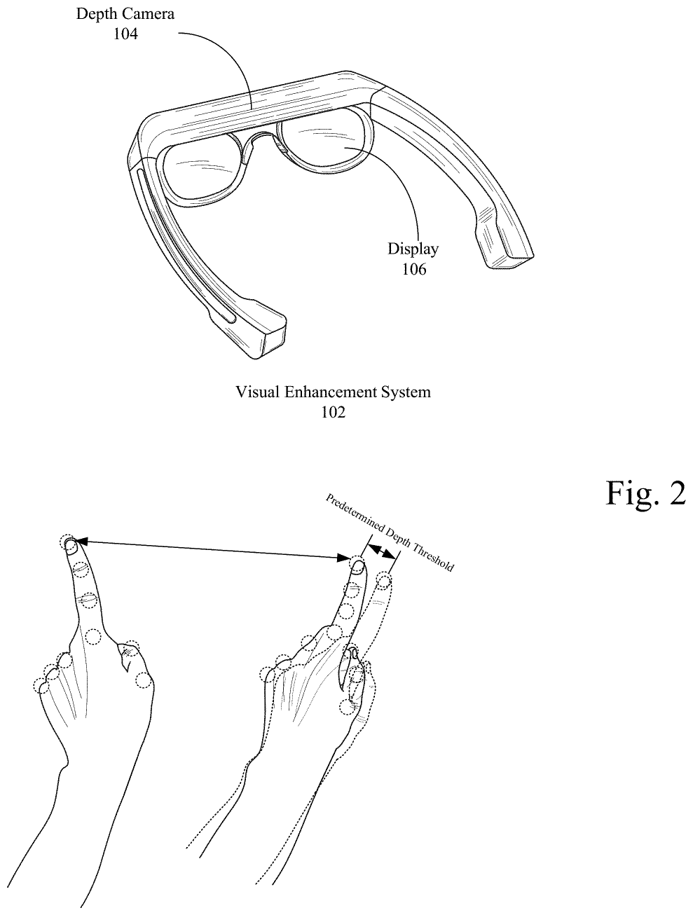

FIG. 2 illustrates the example visual enhancement system 102 configured to recognize other dynamic hand gestures.

Similar to FIG. 1, the depth camera 104 may be configured to collect a depth map that includes three-dimensional information of the joints and fingertips of the hand. The three-dimensional information of the joints and fingertips may include respective distances from the joints and fingertips to the depth camera 104.

The processing unit of the visual enhancement system 102 may be configured to determine a hand gesture based on a count of straightened fingers indicated by the depth map. As depicted, the processing unit may be configured to recognize a hand state that indicates one finger and includes corresponding three-dimensional locations of the joints and fingertips. The hand state may be stored in a hand state history.

Further, the processing unit of the example visual enhancement system 102 may be configured to recognize a current hand state that also indicates one finger and includes three-dimensional locations of the joints and fingertips. By comparing the current hand state with the previously recognized hand state, the processing unit may determine that the current hand gesture is the same as the previously recognized hand gesture but the locations of the joints and fingertips may have changed. Based on the changes of the locations of the joints and fingertips, the processing unit may be configured to calculate displacements of the joints and fingertips.

In some examples, the processing unit may be configured to determine a dynamic hand gesture based on the displacements of the joints and fingertips. For instance, when the displacements of the joints and fingertips indicate movements from left to right, the processing unit may recognize the dynamic hand gesture as “one finger swiping from left to right.” In some other examples, when the displacements of the joints of the one straightened finger exceed a predetermined depth threshold but displacements of other joints of the hand are within the predetermined depth threshold, the processing unit may recognize the dynamic hand gesture as “clicking with one finger.”

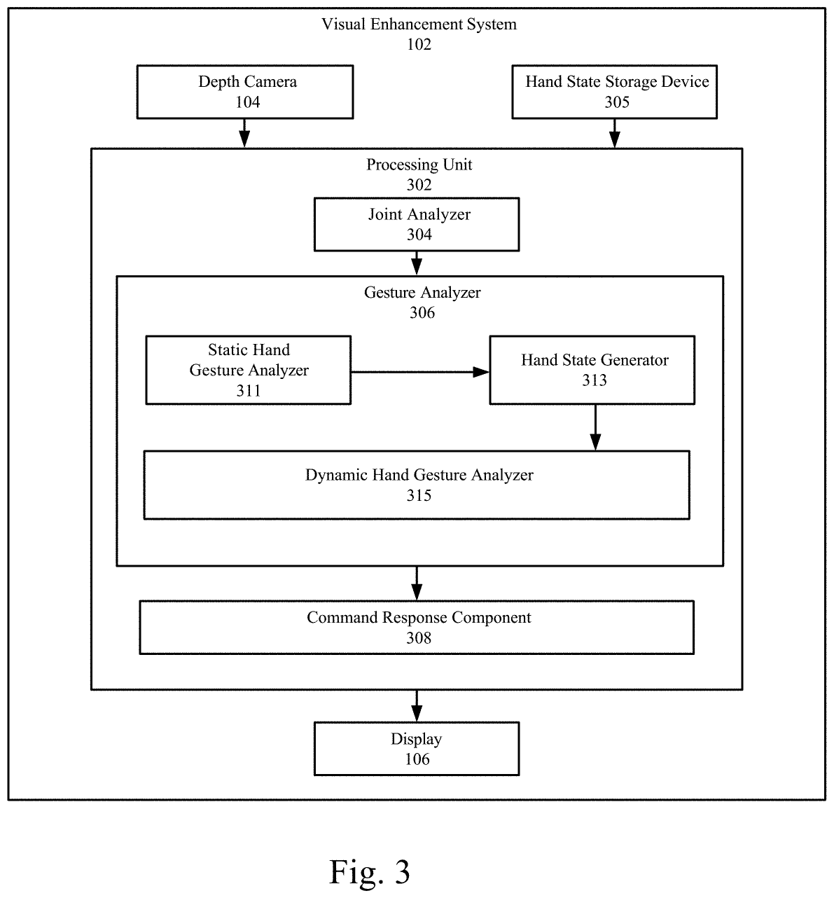

FIG. 3 is a block diagram that illustrates the example visual enhancement system 102 by which command activation based on hand gesture recognition may be implemented.

As described above, the visual enhancement system 102 may include the depth camera 104 configured to collect a depth map of a hand. The depth map may be transmitted by the depth camera 104 to a processing unit 302. Components of the processing unit 302 may be implemented as hardware, firmware, software, or any combination thereof.

Upon receiving the depth map of the hand, a joint analyzer 304 of the processing unit 302 may be configured to identify one or more joints and fingertips of the hand in the depth map. In at least some examples, the joint analyzer 304 may be configured to detect and identify the joints and fingertips based on neural network training that may involve manually labeling of joints in a sufficient number of images. The identified joints and fingertips may be associated with three-dimensional location information and marked in the depth map.

Based on the depth map that includes the identified joints and fingertips, a gesture analyzer 306 may be configured to determine a hand gesture. In more detail, a static hand gesture analyzer 311 included in the gesture analyzer 306 may be configured to count straightened fingers in the depth map. In at least some examples, the static hand gesture analyzer 311 may be configured to determine a straightened finger based on a distance from a corresponding fingertip to a center of the palm of the hand. For instance, when the distance from the corresponding fingertip to the center of the palm is equal to or greater than a predetermined distance, the static hand gesture analyzer 311 may be configured to identify a straightened finger. When the distance from the corresponding fingertip to the center of the palm is less than the predetermined distance, the static hand gesture analyzer 311 may not count the finger as a straightened finger.

In accordance with the number of identified straightened fingers, the static hand gesture analyzer 311 may be configured to determine a hand gesture of the hand in the depth map. For example, if the number of the straightened fingers is five, the static hand gesture analyzer 311 may be configured to determine the hand gesture as an open hand. If the number of the straightened fingers is determined to be one, the static hand gesture analyzer 311 may be configured to determine the hand gesture as one finger. If the number of the straightened fingers is zero, the static hand gesture analyzer 311 may be configured to determine the hand gesture as a fist. Other hand gestures such as two fingers may be similarly determined based on the number of the straightened fingers.

An identified hand gesture may be represented by one of one or more hand gesture code (e.g., “fist” may be represented by a binary code “00”). The hand gesture code may be transmitted to a hand state generator 313 included in the gesture analyzer 306. The hand state generator 313 may be configured to associate the three-dimensional locations of the joints and fingertips with the hand gesture code to generate a hand state. For example, a hand gesture code that indicates an open hand may be associated with the distances between the five fingertips calculated based on the three-dimensional locations of the joints and fingertips. The distances between the five fingertips may indicate how open the hand is, e.g., partially open or fully open. A hand gesture code that indicates one finger may be associated with a distance from the fingertip of the straightened finger to the center of the hand calculated based on the three-dimensional locations of the joints and fingertips.

The hand state generated by the hand state generator 313 may be further stored in a hand state history in a hand state storage device 305. In some examples, the generated hand state may be stored in the hand state history with corresponding time stamps and may be transmitted as a current hand state to a dynamic hand gesture analyzer 315 included in the gesture analyzer 306.

The dynamic hand gesture analyzer 315 may be configured to compare the current hand state with one or more previous hand states in the hand state history to determine a dynamic hand gesture. For example, when the previous hand state in the hand state history is a fist and the current hand state is an open hand, the dynamic hand gesture analyzer 315 may be configured to determine the dynamic hand gesture as “open a hand.” Notably, when the previous hand state is an open hand and the current hand state is also an open hand that opens more, i.e., the distances between the fingertips increased, the dynamic hand gesture analyzer 315 may be configured to determine the dynamic hand gesture as “gradually opening a hand.” In this case, the dynamic hand gesture analyzer 315 may be configured to determine the speed of the opening based on the time stamps associated with the previous hand state.

In some other examples, when the previous hand state in the hand state history is an open hand and the current hand state is a fist, the dynamic hand gesture analyzer 315 may be configured to determine the dynamic hand gesture as “close a hand.” Similarly, when the previous hand state is an open hand and current hand state is also an open hand that opens less, i.e., the distances between the fingertips decreased, the dynamic hand gesture analyzer 315 may be configured to determine the dynamic hand gesture as “gradually closing a hand.”

Further, when a previous hand state in the hand state history is one finger and the current hand state is also one finger, the dynamic hand gesture analyzer 315 may be configured to determine the dynamic hand gesture based on the change of the three-dimensional locations of the joints, i.e., the displacements of the joints.

For instance, when the displacements of the joints and fingertips of the one straightened finger indicate movements from left to right, the dynamic hand gesture analyzer 315 may recognize the dynamic hand gesture as “one finger swiping from left to right.” In some other examples, when the displacements of the joints of the one straightened finger exceed a predetermined depth threshold but displacements of other joints of the hand are within the predetermined depth threshold, the dynamic hand gesture analyzer 315 may recognize the dynamic hand gesture as “clicking with one finger.”

Further, the dynamic hand gesture analyzer 315 may be configured to associate additional information with the determined dynamic hand gesture. The additional information may include displacements of the joints and fingertips. That is, changes of the locations of the joints and fingertips between the current hand state and the previous hand state may be associated with the dynamic hand gesture. For example, the additional information associated with “opening a hand” may include the displacements of the joints from the locations in the previous hand state.

A combination of a dynamic hand gesture and the displacements of the joints and fingertips may be stored and referred to as a gesture command. The dynamic hand gesture analyzer 315 may be configured to transmit the gesture command to a command response component 308.

The command response component 308 may be configured to initiate one or more operations in response to the gesture command. For example, the command response component 308 may be configured to initiate a menu that includes one or more option items in response to a gesture command that includes a dynamic hand gesture determined to be “open a hand.” In some examples, the command response component 308 may be configured to gradually initiate the menu, e.g., gradually increasing the size of the menu, in response to a gesture command that includes a dynamic hand gesture determined to be “gradually opening a hand.”

The command response component 308 may be configured to terminate the menu in response to a gesture command that includes a dynamic hand gesture determined to be “close a hand.” Similarly, the command response component 308 may be configured to gradually close the menu, e.g., gradually decreasing the size of the menu, in response to a gesture command that includes a dynamic hand gesture determined to be “gradually closing a hand.”

Further, the command response component 308 may be configured to move the one or more option items included in the menu from left to right in response to a gesture command that includes a dynamic hand gesture determined to be “one finger swiping from left to right.” In particular, the command response component 308 may be configured to move the one or more option items at a same speed as the finger. Similarly, the command response component 308 may be configured to move the one or more option items included in the menu from right to left in response to a gesture command that includes a dynamic hand gesture determined to be “one finger swiping from right to left.”

Further still, the command response component 308 may be configured to initiate an application or a program that corresponds to one of the option items in response to a gesture command that includes a dynamic hand gesture as “clicking with one finger.”

The menu and the option items may be displayed on the display 106 during the process described above. The display 106 may include a DLP projector or LCOS micro-display, or an OLED display, or a laser MEMS scanner.

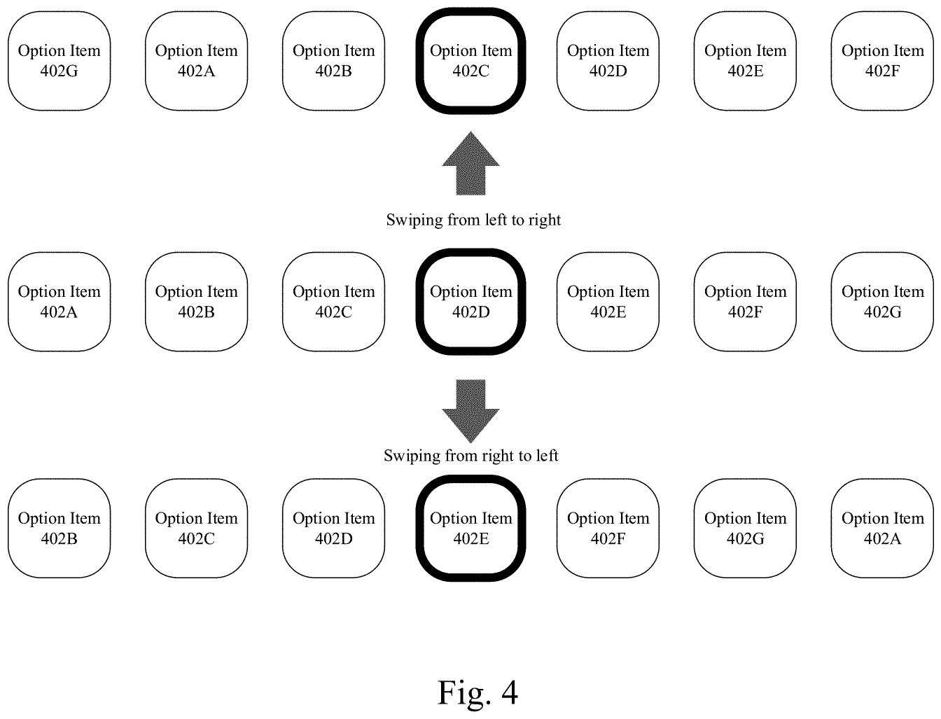

FIG. 4 illustrates an example menu displayed by the example visual enhancement system in response to one or more gesture command.

As depicted, the display 106 may be configured to display a menu that include one or more option items, e.g., option items 402A-402G. Each option item may correspond to an application or a program. The option items 402A-402G may be displayed in a row as illustrated in FIG. 4. In some other examples, the option items 402A-402G may be displayed in a circle. The option item at the center, e.g., option item 402D, may be displayed differently from other option items to indicate that the option item at the center is the currently selected option item.

In response to a gesture command that includes a dynamic hand gesture determined to be “one finger swiping from left to right,” the command response component 308 may be configured to move all the option items to the right. Similarly, in response to a gesture command that includes a dynamic hand gesture determined to be “one finger swiping from right to left,” the command response component 308 may be configured to move all the option items to the left.

In at least some examples, the command response component 308 may be configured to move the option items 402A-402G at a same speed as the finger and to stop the moving of the option items when the finger stops. The speed of the finger may be calculated based on the displacements of the joints and fingertips and the respective time stamps associated with the previous hand state and the current hand state. In these examples, the option items 402A-402G may be moved along with the finger at the same speed and stopped when the finger stops. The currently selected option item may an option item located at the center when the finger stops, e.g., the option item 402C or the option item 402E.

In response to a gesture command that includes a dynamic hand gesture as “clicking with one finger,” the command response component 308 may be configured to initiate an application that corresponds to the currently selected option item.

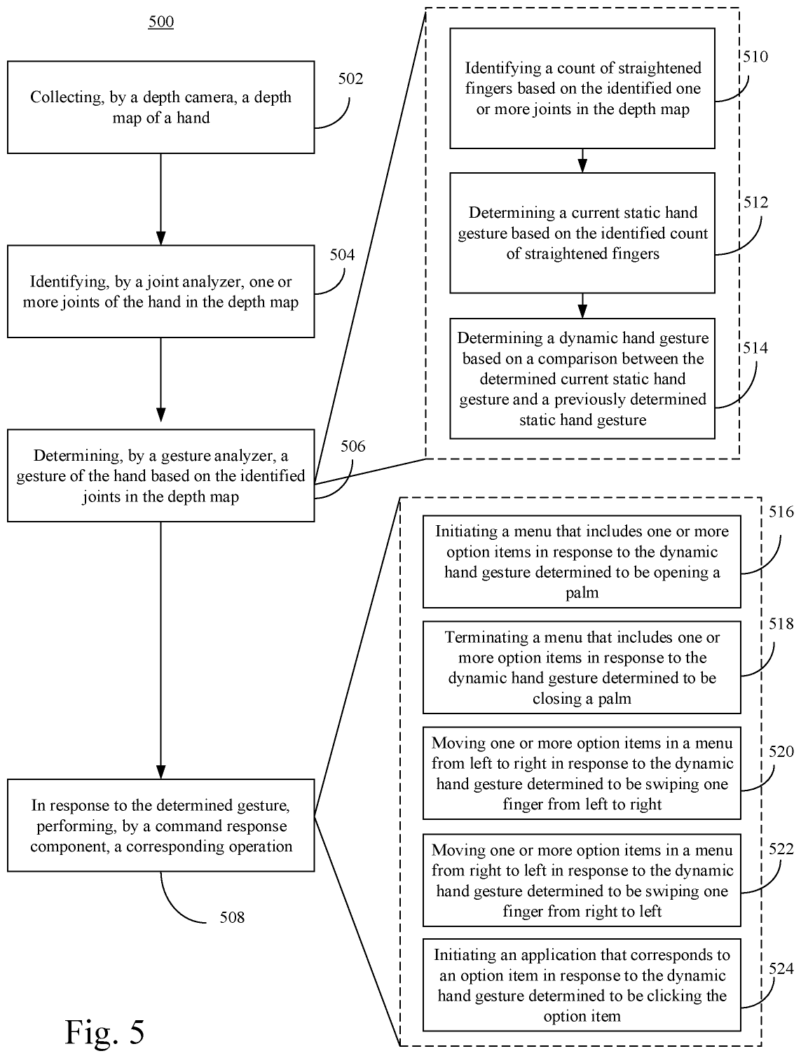

FIG. 5 is a flow chart of an example method 500 for command activation based on hand gesture recognition. Operations included in the example method 500 may be performed by the components described in accordance with FIG. 3.

At block 502, the example method 500 may include collecting, by a depth camera, a depth map of a hand. For example, the depth camera 104 may be configured to measure the respective round-trip time of light signals emitted from the camera to the one or more objects and reflected from the objects to the camera. By measuring the round-trip time of the light signals, the depth camera 104 may be configured to determine the distances based on the known speed of light. As such, an object captured by the depth camera 104 may be associated with a three-dimensional location that includes coordinates in a two-dimensional image and a distance. In other examples, the depth camera 104 may be based on structured light or stereo vision system.

At block 504, the example method 500 may include identifying, by a joint analyzer, one or more joints of the hand in the depth map. For example, the joint analyzer 304 of the processing unit 302 may be configured to identify one or more joints and fingertips of the hand in the depth map. In at least some examples, the joint analyzer 304 may be configured to detect and identify the joints and fingertips based on neural network training that may involve manually labeling of joints in a sufficient number of images. The identified joints and fingertips may be associated with three-dimensional location information and marked in the depth map

At block 506, the example method 500 may include determining, by a gesture analyzer, a gesture of the hand based on the identified joints in the depth map. For example, the gesture analyzer 306 may be configured to determine a hand gesture based on the identified joints and fingertips in the depth map. Sub-operations of block 506 may be indicated in blocks 510, 512, and 514.

At block 510, the example method 500 may include identifying a count of straightened fingers based on the identified one or more joints in the depth map. For example, the static hand gesture analyzer 311 included in the gesture analyzer 306 may be configured to count straightened fingers in the depth map. In at least some examples, the static hand gesture analyzer 311 may be configured to determine a straightened finger based on a distance from a corresponding fingertip to a center of the palm of the hand. For instance, when the distance from the corresponding fingertip to the center of the palm is equal to or greater than a predetermined distance, the static hand gesture analyzer 311 may be configured to identify a straightened finger. When the distance from the corresponding fingertip to the center of the palm is less than the predetermined distance, the static hand gesture analyzer 311 may not count the finger as a straightened finger.

At block 512, the example method 500 may include determining a current static hand gesture based on the identified count of straightened fingers. For example, the static hand gesture analyzer 311 may be configured to determine a hand gesture of the hand in the depth map. For example, if the number of the straightened fingers is five, the static hand gesture analyzer 311 may be configured to determine the hand gesture as an open hand. If the number of the straightened fingers is determined to be one, the static hand gesture analyzer 311 may be configured to determine the hand gesture as one finger. If the number of the straightened fingers is zero, the static hand gesture analyzer 311 may be configured to determine the hand gesture as a fist. Other hand gestures such as two fingers may be similarly determined based on the number of the straightened fingers.

An identified hand gesture may be represented by one of one or more hand gesture code (e.g., “fist” may be represented by a binary code “00”). The hand gesture code may be transmitted to a hand state generator 313 included in the gesture analyzer 306. The hand state generator 313 may be configured to associate the three-dimensional locations of the joints and fingertips with the hand gesture code to generate a hand state. For example, a hand gesture code that indicates an open hand may be associated with the distances between the five fingertips calculated based on the three-dimensional locations of the joints and fingertips. The distances between the five fingertips may indicate how open the hand is, e.g., partially open or fully open. A hand gesture code that indicates one finger may be associated with a distance from the fingertip of the straightened finger to the center of the palm calculated based on the three-dimensional locations of the joints and fingertips.

The hand state generated by the hand state generator 313 may be further stored in a hand state history in a hand state storage device 305. In some examples, the generated hand state may be stored in the hand state history with corresponding time stamps and may be transmitted as a current hand state to a dynamic hand gesture analyzer 315 included in the gesture analyzer 306.

At block 514, the example method 500 may include determining a dynamic hand gesture based on a comparison between the determined current static hand gesture and a previously determined static hand gesture. For example, the dynamic hand gesture analyzer 315 may be configured to compare the current hand state with one or more previous hand states in the hand state history to determine a dynamic hand gesture. For example, when the previous hand state in the hand state history is a fist and the current hand state is an open hand, the dynamic hand gesture analyzer 315 may be configured to determine the dynamic hand gesture as “open a hand.” Notably, when the previous hand state is an open hand and the current hand state is also an open hand that opens more, i.e., the distances between the fingertips increased, the dynamic hand gesture analyzer 315 may be configured to determine the dynamic hand gesture as “gradually opening a hand.” In this case, the dynamic hand gesture analyzer 315 may be configured to determine the speed of the opening based on the time stamps associated with the previous hand state.

In some other examples, when the previous hand state in the hand state history is an open hand and the current hand state is a fist, the dynamic hand gesture analyzer 315 may be configured to determine the dynamic hand gesture as “close a hand.”

Further, when a previous hand state in the hand state history is one finger and the current hand state is also one finger, the dynamic hand gesture analyzer 315 may be configured to determine the dynamic hand gesture based on the change of the three-dimensional locations of the joints, i.e., the displacements of the joints.

For instance, when the displacements of the joints and fingertips of the one straightened finger indicate movements from left to right, the dynamic hand gesture analyzer 315 may recognize the dynamic hand gesture as “one finger swiping from left to right.” In some other examples, when the displacements of the joints of the one straightened finger exceed a predetermined depth threshold but displacements of other joints of the hand are within the predetermined depth threshold, the dynamic hand gesture analyzer 315 may recognize the dynamic hand gesture as “clicking with one finger.”

Further, the dynamic hand gesture analyzer 315 may be configured to associate additional information with the determined dynamic hand gesture. The additional information may include displacements of the joints and fingertips. That is, changes of the locations of the joints and fingertips between the current hand state and the previous hand state may be associated with the dynamic hand gesture. For example, the additional information associated with “opening a hand” may include the displacements of the joints from the locations in the previous hand state.

A combination of a dynamic hand gesture and the displacements of the joints and fingertips may be stored and referred to as a gesture command. The dynamic hand gesture analyzer 315 may be configured to transmit the gesture command to a command response component 308.

At block 508, the example method 500 may include in response to the determined gesture, performing, by a command response component, a corresponding operation. For example, the command response component 308 may be configured to initiate one or more operations in response to the gesture command. Sub-operations of block 508 may be indicated in blocks 516, 518, 520, 522, and 524.

At block 516, the example method may include initiating a menu that includes one or more option items in response to the dynamic hand gesture determined to be opening a hand. For example, the command response component 308 may be configured to initiate a menu that includes one or more option items in response to a gesture command that includes a dynamic hand gesture determined to be “open a hand.” In some examples, the command response component 308 may be configured to gradually initiate the menu, e.g., gradually increasing the size of the menu, in response to a gesture command that includes a dynamic hand gesture determined to be “gradually opening a hand.”

At block 518, the example method may include terminating a menu that includes one or more option items in response to the dynamic hand gesture determined to be closing a hand. For example, the command response component 308 may be configured to terminate the menu in response to a gesture command that includes a dynamic hand gesture determined to be “close a hand.” Similarly, the command response component 308 may be configured to gradually close the menu, e.g., gradually decreasing the size of the menu, in response to a gesture command that includes a dynamic hand gesture determined to be “gradually closing a hand.”

At block 520, the example method may include moving one or more option items in a menu from left to right in response to the dynamic hand gesture determined to be swiping one finger from left to right. For example, the command response component 308 may be configured to move the one or more option items included in the menu from left to right in response to a gesture command that includes a dynamic hand gesture determined to be “one finger swiping from left to right.” In at least some examples, the command response component 308 may be configured to move the option items at a same speed as the finger and to stop the moving of the option items when the finger stops. The speed of the finger may be calculated based on the displacements of the joints and fingertips and the respective time stamps associated with the previous hand state and the current hand state.

At block 522, the example method may include moving one or more option items in a menu from right to left in response to the dynamic hand gesture determined to be swiping one finger from right to left. For example, the command response component 308 may be configured to move the one or more option items included in the menu from right to left in response to a gesture command that includes a dynamic hand gesture determined to be “one finger swiping from right to left.” Similarly, the command response component 308 may be configured to move the option items at a same speed as the finger and to stop the moving of the option items when the finger stops.

At block 524, the example method may include initiating an application that corresponds to an option item in response to the dynamic hand gesture determined to be clicking the option item. For example, the command response component 308 may be configured to initiate an application or a program that corresponds to one of the option items in response to a gesture command that includes a dynamic hand gesture as “clicking with one finger.”

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

What is claimed:

1. A method of user interaction in a visual enhancement system, comprising:
collecting, by a depth camera, a depth map of a hand;
identifying, by a joint analyzer, one or more joints of the hand in the depth map;
determining, by a gesture analyzer, a gesture of the hand based on the identified joints in the depth map; and
in response to the determined gesture, performing, by a command response component, a corresponding operation.

2. The method of claim 1, wherein the depth map includes information relating to distances between one or more respective portions of the hand and the depth camera.

3. The method of claim 1, wherein the determining the gesture includes identifying a count of straightened fingers based on the identified one or more joints in the depth map.

4. The method of claim 3, wherein the determining the gesture further includes determining a current static hand gesture based on the identified count of straightened fingers.

5. The method of claim 4, wherein the determining the gesture further includes determining a dynamic hand gesture based on a comparison between the determined current static hand gesture and a previously determined static hand gesture.

6. The method of claim 5, wherein the dynamic hand gesture is determined to be a gesture selected from gradually closing a hand, gradually opening a hand, close a hand, open a hand swiping one finger from left to right, clicking with one or more of the straightened fingers, or swiping one finger right to left.

7. The method of claim 6, wherein the performing the corresponding operation includes initiating a menu that includes one or more option items in response to the dynamic hand gesture determined to be open a hand.

8. The method of claim 6, wherein the performing the corresponding operation includes terminating a menu that includes one or more option items in response to the dynamic hand gesture determined to be close a hand.

9. The method of claim 6, wherein the performing the corresponding operation includes moving one or more option items in a menu from left to right in response to the dynamic hand gesture determined to be swiping one finger from left to right.

10. The method of claim 6, wherein the performing the corresponding operation includes moving one or more option items in a menu from right to left in response to the dynamic hand gesture determined to be swiping one finger from right to left.

11. The method of claim 6, wherein the performing the corresponding operation includes initiating an application that corresponds to an option item in response to the dynamic hand gesture determined to be clicking the option item.

12. A system for user interaction in a visual enhancement system, comprising:
a depth camera configured to collect a depth map of a hand;
a joint analyzer configured to identify one or more joints of the hand in the depth map;
a gesture analyzer configured to determine a gesture of the hand based on the identified joints in the depth map; and
a command response component configured to perform a corresponding operation in response to the determined gesture.

13. The system of claim 12, wherein the depth map includes information relating to distances between one or more portions of the hand and the depth camera.

14. The system of claim 12, wherein the gesture analyzer is configured to identify a count of straightened fingers based on the identified one or more joints in the depth map.

15. The system of claim 14, wherein the gesture analyzer is configured to determine a current static hand gesture based on the identified count of straightened fingers.

16. The system of claim 15,
wherein the system further comprises a hand state storage device,
wherein the gesture analyzer is configured to determine a dynamic hand gesture based on a comparison between the determined current static hand gesture and a previously determined static hand gesture stored in the hand state storage device.

17. The system of claim 16, wherein the dynamic hand gesture is determined to be a gesture selected from gradually closing a hand, gradually opening a hand, close a hand, open a hand, swiping one finger from left to right, clicking with one or more of the straightened fingers, or swiping one finger right to left.

18. The system of claim 17, wherein the command response component is configured to initiate a menu that includes one or more option items in response to the dynamic hand gesture determined to be open a hand.

19. The system of claim 17, wherein the command response component is configured to terminate a menu that includes one or more option items in response to the dynamic hand gesture determined to be close a hand.

20. The system of claim 17, wherein the command response component is configured to move one or more option items in a menu from left to right in response to the dynamic hand gesture determined to be swiping one finger from left to right.

21. (canceled)

22. (canceled)
